(19) United States
(12) Patent Application Publication
(10) Pub. No.: US 2026/0091477 A1
(43) Pub. Date: Apr. 2, 2026

(54) POWER TOOL AND METHOD OF CONTROLLING THE SAME

(71) Applicant: BASSO INDUSTRY CORP., Taichung (TW)

(72) Inventors: Cheng-En TSAI, Taichung (TW); Shuo-Tsung WONG, Taichung (TW)

(73) Assignee: BASSO INDUSTRY CORP., Taichung (TW)

(21) Appl. No.: 19/341,406

(22) Filed: Sep. 26, 2025

(30) Foreign Application Priority Data
Sep. 30, 2024 (TW) 113137302

(51) Int. Cl. B25F 5/02; H02P 23/14; H02P 23/20

(52) U.S. Cl. CPC B25F 5/02; H02P 23/14; H02P 23/20

(57) ABSTRACT

A method of controlling a power tool is implemented by a controller of the power tool. The method includes: receiving a current value of a motor of the power tool, and obtaining a current weight value based on the current value and a predetermined number of weight levels; receiving a plurality of acceleration signals from an accelerometer of the power tool; obtaining an angular acceleration value based on the acceleration signals; obtaining a deciding value based on the current weight value and the angular acceleration value; and in response to a predetermined condition being met, stopping operation of the motor. The predetermined condition includes the controller determining that the deciding value is greater than a threshold value, and that the power tool is in an operating mode.

### CROSS-REFERENCE TO RELATED APPLICATION

This application claims priority to Taiwanese Invention patent application No. 113137302, filed on Sep. 30, 2024, the entire disclosure of which is incorporated by reference herein.

### FIELD

The disclosure relates to a power tool and a method of controlling a power tool.

### BACKGROUND

A conventional power tool, such as an electric screwdriver, electric drill or hammer drill, may, during rotational operations (e.g., screw fastening or drilling), sometimes have its working end locked by the workpiece. When this happens the rotational force of the conventional power tool may generate a reaction force on the conventional power tool itself in the opposite direction of the rotational force, which may result in the operator's hand being twisted along with the conventional power tool (a phenomenon commonly referred to as “kickback”). Such situations can easily lead to twisting and injury of the operator's hand, or, if the conventional power tool slips out of the operator's grip and falls, may result in damage of the conventional power tool or even more serious industrial safety accidents.

To address the above problem, a conventional approach is to stop the operation of the motor of the conventional power tool when a kickback situation is determined to be imminent, thereby preventing excessive rotation of the conventional power tool and reducing the risk of industrial safety accidents. A conventional method of determining when a kickback situation is imminent is to detect whether an impact has occurred or whether the conventional power tool has undergone excessive twisting. However, when the conventional power tool is used for hammer drilling on concrete, the hardness of the concrete and the large vibrations generated often cause the conventional method of determination to misinterpret the vibrations as an impact, which leads to the incorrect determination that a kickback situation has occurred. Furthermore, when hammer drilling into concrete, operators often intentionally twist the conventional power tool to change the drilling angle, which can also be easily misinterpreted as a kickback situation. Such misjudgments may cause the conventional power tool to stop operating frequently and unnecessarily, resulting in significant inconvenience when in use.

### SUMMARY

Therefore, an object of the disclosure is to provide a method of controlling a power tool, and a power tool that can alleviate at least one of the drawbacks of the prior art.

According to an aspect of the disclosure, the method is implemented by a controller of the power tool. The power tool includes an accelerometer, a motor, a current detection circuit for detecting a current of the motor, and the controller. The method includes: receiving a current value of the motor from the current detection circuit, and obtaining a current weight value based on the current value and a predetermined number of weight levels; receiving a plurality of acceleration signals corresponding to different points of time from the accelerometer, the accelerometer measuring acceleration of the accelerometer on a work plane over time to generate the acceleration signals, the work plane having an A-axis, and a B-axis that is perpendicular to the A-axis, each of the acceleration signals including an A-axis acceleration value related to an acceleration measured along the A-axis, and a B-axis acceleration value related to an acceleration measured along the B-axis; obtaining an angular acceleration value based on the acceleration signals, the angular acceleration value corresponding to an angular acceleration of the power tool on the work plane; obtaining a deciding value based on the current weight value and the angular acceleration value; and in response to a predetermined condition being met, stopping operation of the motor. The predetermined condition includes determining that the deciding value is greater than a threshold value, and that the power tool is in an operating mode.

According to another aspect of the disclosure, the power tool includes an accelerometer, a motor, a current detection circuit, and a controller. The accelerometer is configured to measure acceleration of the accelerometer along a work plane over time to generate a plurality of acceleration signals corresponding to different points of time. The work plane has an A-axis, and a B-axis that is perpendicular to the A-axis. Each of the acceleration signals includes an A-axis acceleration value related to an acceleration measured along the A-axis, and a B-axis acceleration value related to an acceleration measured along the B-axis. The motor is configured to receive a control signal, and operate based on the control signal thus received. The current detection circuit is disposed in correspondence to the motor, and is configured to detect a current of the motor to output a current signal indicating a current value of the motor based on the current thus detected. The controller is electrically connected to the accelerometer, the motor, and the current detection circuit. The controller is configured to receive the acceleration signals and the current signal, output the control signal, and perform the method of this disclosure.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a cross sectional view illustrating a power tool according to an embodiment of the present disclosure.

FIG. 2 is a schematic block diagram of the power tool according to an embodiment of the present disclosure.

FIG. 3 is a schematic diagram illustrating a work plane and a rotation axis according to an embodiment of the present disclosure.

FIG. 4 is a circuit block diagram illustrating a connection between an accelerometer module and a controller according to an embodiment of the present disclosure.

FIG. 5 is a flow chart illustrating a method of controlling a power tool according to an embodiment of the present disclosure.

FIG. 6 is a waveform diagram illustrating current values of a motor detected by a current detection circuit according to an embodiment of the present disclosure.

FIG. 7 is a waveform diagram illustrating current weight values obtained based respectively on the current values in FIG. 6.

FIG. 8 is a waveform diagram illustrating acceleration values measured by an accelerometer respectively along an X-axis, a Y-axis, and a Z-axis according to an embodiment of the present disclosure.

FIG. 9 is a waveform diagram illustrating angular acceleration values obtained by the controller according to an embodiment of the present disclosure.

FIG. 10 is a waveform diagram illustrating the current weight values overlapping with the angular acceleration values according to an embodiment of the present disclosure.

FIG. 11 is a waveform diagram illustrating deciding values obtained based on the current weight values and the angular acceleration values in FIG. 10.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

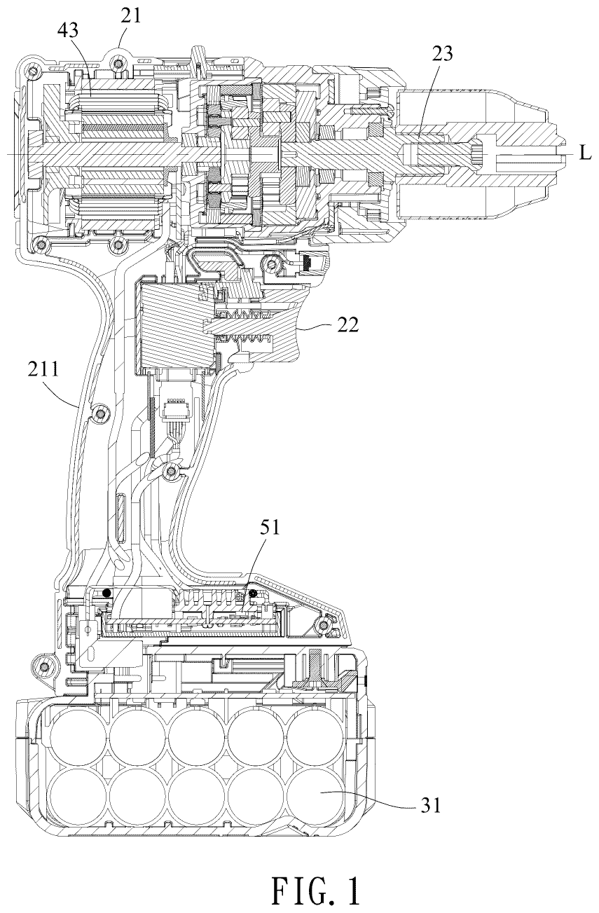

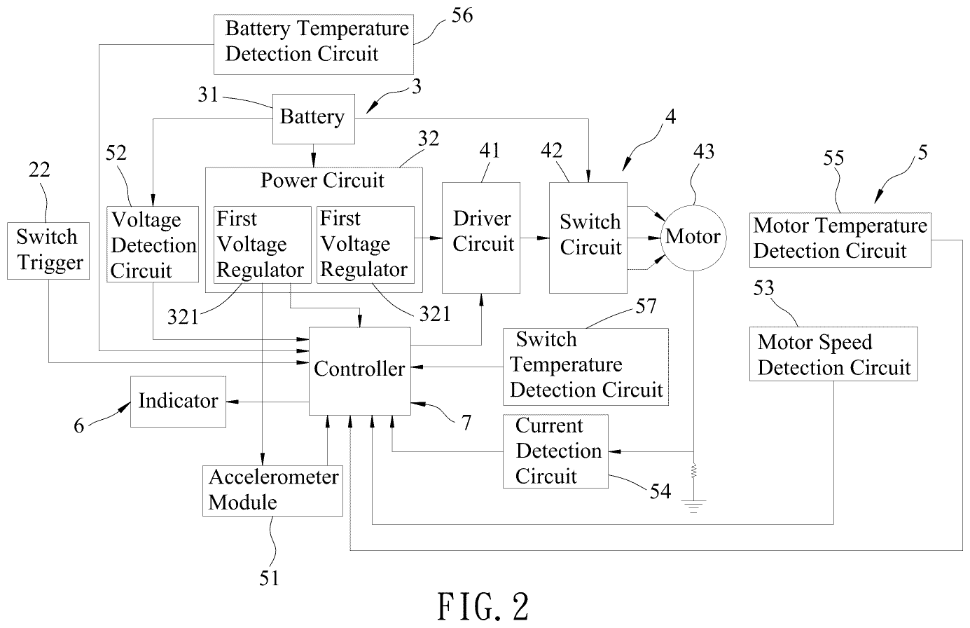

Referring to FIGS. 1 and 2, a power tool according to an embodiment of the present disclosure includes a housing 21, a switch trigger 22, a chuck 23, a power supply unit 3, a motor unit 4, a detection unit 5, an indicator 6, and a controller 7.

The housing 21 includes a grip handle 211 for holding by an operator. The switch trigger 22 is disposed on the grip handle 211 for pressing by the operator, and is configured to output a trigger signal to the controller 7 upon being depressed. The chuck 23 has a rotation axis (L), extends along the rotation axis (L), and is disposed in a front portion (i.e., the right side with respect to FIG. 1) of the housing 21. The chuck 23 is configured to hold a rotary tool such as a drill bit, driver bit, or nut driver bit, and is driven to rotate, thereby driving the rotary tool to rotate about the rotation axis (L).

The power supply unit 3 includes a battery 31 disposed in the housing 21, and a power circuit 32 electrically connected to the battery 31. The power circuit 32 is configured to stabilize and adjust the voltage of power supplied by the battery 31, and supply the power thus stabilized and adjusted to internal circuits of the power tool. In one embodiment, the power circuit 32 includes a plurality of first voltage regulators 321 for respectively providing power of different voltages (e.g., 3.3 V and 5 V). In one embodiment, the first voltage regulators 321 are exemplified as low-dropout (LDO) regulators, but the disclosure is not limited in this respect.

The motor unit 4 includes a driver circuit 41, a switch circuit 42, and a motor 43. The driver circuit 41 is configured to receive the power provided by the power circuit 32, and receive a control signal in a form of a pulse width modulation (PWM) signal from the controller 7. The driver circuit 41 is further configured to control the switch circuit 42 to drive the motor 43 to rotate at a target rotational speed according to a duty ratio of the PWM signal (i.e., the control signal) thus received. In one embodiment, the switch circuit 42 is implemented using one or more metal-oxide-semiconductor field-effect transistors (MOSFETs), but is not limited to such. In one embodiment, the motor 43 is exemplified as a brushless direct current (BLDC) motor, but the disclosure is not limited to such.

The detection unit 5 includes an accelerometer module 51, a voltage detection circuit 52, a motor speed detection circuit 53, a current detection circuit 54, a motor temperature detection circuit 55, a battery temperature detection circuit 56, and a switch temperature detection circuit 57.

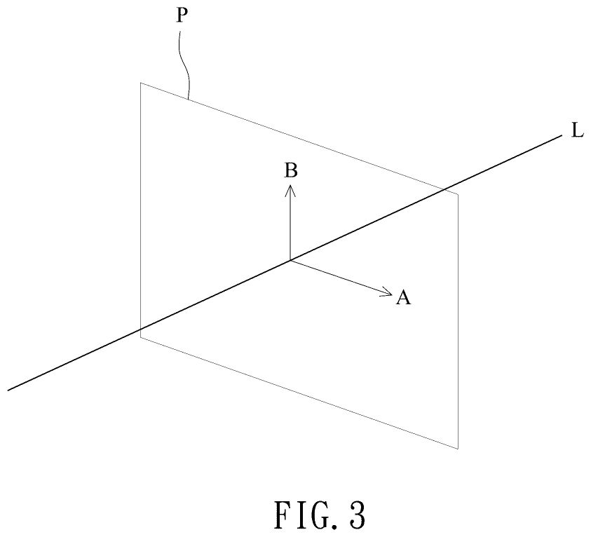

Referring to FIGS. 1, 3 and 4, the accelerometer module 51 is disposed in the grip handle 211, and includes a second voltage regulator 531, an accelerometer 511 and a voltage converter circuit 512. The accelerometer 511 is configured to measure its own acceleration on a work plane (P) over time to generate a plurality of acceleration signals corresponding to different points of time. Specifically, the accelerometer 511 continuously measures acceleration as a function of time and outputs the acceleration signals at different time intervals. It should be noted that the statement that the accelerometer 511 generates acceleration signals should not be construed to mean that the power tool has multiple accelerometers for outputting the acceleration signals or that the accelerometer 511 outputs all of the acceleration signals in a single output each time. The work plane (P) intersects the rotation axis (L). In one embodiment, the work plane (P) is perpendicular to the rotation axis (L), but the disclosure is not limited in this respect. The work plane (P) has an A-axis, and a B-axis that is perpendicular to the A-axis. Each of the acceleration signals includes an A-axis acceleration value related to an acceleration measured along the A-axis, and a B-axis acceleration value related to an acceleration measured along the B-axis. The second voltage regulator 531 is exemplified as an LDO regulator, but is not limited to such. In one embodiment, the accelerometer 511 is exemplified as a two-axis accelerometer or a three-axis accelerometer, but the disclosure is not limited to such. In this embodiment, the accelerometer 511 is the three-axis accelerometer for example. Specifically, a Y-axis of the three-axis accelerometer is parallel to the rotation axis (L), and an X-axis and a Z-axis of the three-axis accelerometer respectively correspond to the A-axis and the B-axis of the work plane (P).

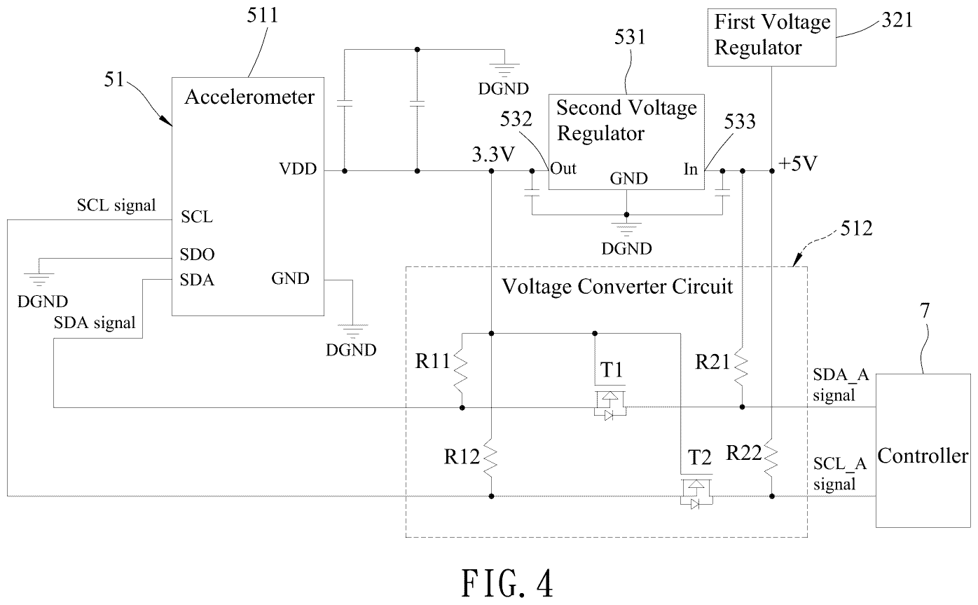

Referring to FIGS. 2, 3 and 4, the voltage converter circuit 512 is electrically connected between the accelerometer 511 and the controller 7. The voltage converter circuit 512 is configured to perform bidirectional voltage conversion for signal transmission between the accelerometer 511 (operating at 3.3 V) and the controller 7 (operating at 5 V). Referring to FIG. 4, signals that are received or outputted respectively from a serial data (SDA) terminal and a serial clock (SCL) terminal of the accelerometer 511 are respectively represented as “SDA signal” and “SCL signal”, and signals that are received or outputted respectively at terminals of the controller 7 that correspond respectively to the SDA terminal and the SCL terminal of the accelerometer 511 are respectively represented as “SDA_A signal” and “SCL_A signal”. Specifically, the SDA signal and the SCL signal correspond respectively to the SDA_A signal and the SCL_A signal. The voltage converter circuit 512 includes transistors (T1, T2), low-voltage resistors (R11, R12), and high-voltage resistors (R21, R22). In one embodiment, each of the transistors (T1, T2) is exemplified as an N-type channel MOSFET, but the disclosure is not limited to such. Each of the transistors (T1, T2) has a source terminal, a gate terminal and a drain terminal. The second voltage regulator 531 includes a low-voltage output terminal 532 and a high-voltage input terminal 533. Each of the low-voltage resistors (R11, R12) has an end that is electrically connected to the accelerometer 511 and the source terminal of a respective one of the transistors (T1, T2), and another end that is electrically connected to the gate terminals of the transistors (T1, T2), and the low-voltage output terminal 532 of the second voltage regulator 531 (e.g., for receiving power of 3.3 V). Each of the high-voltage resistors (R21, R22) has an end that is electrically connected to the controller 7 and the drain terminal of a respective one of the transistors (T1, T2), and another end that is electrically connected to the high-voltage input terminal 533 of the second voltage regulator 531 (e.g., for receiving power of 5 V).

For the SDA signal and the SDA_A signal, in a case when the accelerometer 511 outputs an SDA signal that is at a high level (e.g., having 3.3 V), the transistor (T1) is turned off, and the high-voltage resistor (R21) pulls the SDA_A signal up to a high level (e.g., having 5 V). When the accelerometer 511 outputs an SDA signal that is at a low level (e.g., having 0 V), the transistor (T1) is turned on, and the high-voltage resistor (R21) pulls the SDA_A signal down to a low level (e.g., having 0 V). In another case when the controller 7 outputs an SDA_A signal that is at a high level (e.g., having 5 V), the transistor (T1) is turned off, and the low-voltage resistor (R11) pulls the SDA signal up to a high level (e.g., having 3.3 V). When the controller 7 outputs an SDA_A signal that is at a low level (e.g., having 0 V), the transistor (T1) is turned off, and the SDA signal at the source terminal of the transistor (T1) is pulled down to a low level (0 V) via an intrinsic body diode of the transistor (T1).

The voltage detection circuit 52 is electrically connected to the battery 31 and the controller 7, and is configured to detect a voltage value of the battery 31, and output the voltage value thus detected to the controller 7. The motor speed detection circuit 53 is disposed in correspondence to the motor 43, and is configured to detect a rotor position of the motor 43, and output the rotor position of the motor 43 to the controller 7 in order for the controller 7 to determine a rotational speed of the motor 43 based on the rotor position of the motor 43. The motor speed detection circuit 53 is exemplified as a Hall sensor, but the disclosure is not limited in this respect. The current detection circuit 54 is disposed in correspondence to the motor 43, and is configured to detect a current of the motor 43 to generate a current signal indicating a current value of the motor 43 based on the current thus detected, and output the current signal to the controller 7.

The motor temperature detection circuit 55, the battery temperature detection circuit 56, and the switch temperature detection circuit 57 are electrically connected to the controller 7, and are configured to respectively measure temperatures respectively of the motor 43, the battery 31, and the switch circuit 42, and output the temperatures thus measured to the controller 7 to allow the controller 7 to monitor the temperatures of the motor 43, the battery 31, and the switch circuit 42 and to determine whether the temperatures are abnormal. The motor temperature detection circuit 55, the battery temperature detection circuit 56, and the switch temperature detection circuit 57 may each include a negative temperature coefficient (NTC) resistor, and may each use series resistors to achieve voltage division to measure temperature, but the disclosure is not limited in this respect.

The indicator 6 is exemplified as a light-emitting diode (LED), but the disclosure is not limited to such. The indicator 6 is configured to emit light based on a light signal.

The controller 7 is communicatively connected to the power supply unit 3, the motor unit 4, the detection unit 5, and the indicator 6. The controller 7 is configured to receive the acceleration signals and the current signal, and output the control signal and the light signal. The controller 7 may be exemplified as an integrated circuit that is capable of, for example, analog-to-digital (A/D) conversion, input/output (I/O) detection, PWM signal generation, computational capabilities, etc. In one example, the controller 7 is exemplified as a microcontroller unit (MCU), although the disclosure is not limited thereto.

A method of controlling a power tool according to an embodiment of the disclosure is implemented by the power tool in FIG. 1. The method includes steps of (A) to (E).

In step (A), the controller 7 receives the current value of the motor 43 from the current detection circuit 54, and obtains a current weight value based on the current value and a predetermined number of weight levels.

When the predetermined number of weight levels is N, the predetermined number of weight levels corresponds to (N−1) number of different current thresholds that define N number of current regions, where N is a positive integer greater than one. The N number of current regions correspond respectively to N number of weight levels. N number of different weight values are respectively assigned to the N number of current regions, and are positively correlated with current levels represented by the N number of current regions, respectively. By virtue of the aforementioned arrangement, the controller 7 obtains the current weight value by selecting one of the N number of current regions that covers the current value of the motor 43, and selecting one of the N number of different weight values that corresponds to said one of the N number of current regions as the current weight value.

For example, when the predetermined number of weight levels is two (i.e., N=2), and corresponds to a current threshold, the controller 7 sets the current weight value to a high weight value in response to the current value of the motor 43 being greater than the current threshold, and sets the current weight value to a low weight value that is smaller than the high weight value in response to the current value of the motor 43 being otherwise.

In another example, when the predetermined number of weight levels is three (i.e., N=3), and corresponds to a first current threshold, and a second current threshold that is smaller than the first current threshold (i.e., the number of different current thresholds=3−1=2), the controller 7 sets the current weight value to a high weight value in response to the current value of the motor 43 being greater than the first current threshold, sets the current weight value to a medium weight value in response to the current value of the motor 43 not being greater than the first current threshold and greater and the second current threshold, and sets the current weight value to a low weight value in response to the current value of the motor 43 being otherwise. In this example, the high weight value is greater than the medium weight value, and the medium weight value is greater than the low weight value.

In this embodiment, the predetermined number of weight levels is two, the high weight value is set as 1, and the low weight value is set as 0. The current threshold may be determined according to practical requirement. For example, the current threshold may be set as an average current value of the motor 43.

In step (B), the controller 7 receives the acceleration signals from the accelerometer 511.

In step (C), the controller 7 obtains an angular acceleration value based on the acceleration signals. The angular acceleration value corresponds to an angular acceleration of the power tool on the work plane (P). In one embodiment, the controller 7 obtains the angular acceleration value by identifying time points where the B-axis acceleration values are positive, and extracting those of the acceleration signals that correspond respectively to the time points thus identified, and calculates the angular acceleration value based on the A-axis acceleration values and the B-axis acceleration values of those of the acceleration signals.

Since a kickback situation only occurs in one rotational direction (i.e., clockwise or anti-clockwise) of the motor 43 at a time of occurrence, the controller 7 only performs calculations on those of the acceleration signals whose B-axis acceleration values are positive, which correspond to the rotational direction of the motor 43 at the time, and do not perform calculations on those of the acceleration signals that are otherwise. In this embodiment, in order to maintain continuity along the time axis of a waveform diagram of acceleration value versus time, the angular acceleration values corresponding to those of the acceleration signals whose B-axis acceleration values are negative are set to 0.

In calculating the angular acceleration value, the controller 7 performs a differencing operation on the A-axis acceleration values and the B-axis acceleration values of those of the acceleration signals (i.e., the extracted ones of the acceleration signals), and calculates the angular acceleration value based on results obtained from performing the differencing operation.

In performing the differencing operation, for each time point along the time axis, the controller 7 subtracts the value at a previous time point from the value at the time point to obtain a difference in value for each time interval. The angular acceleration value at each time point is then calculated based on the difference in value for each time interval. Since the differencing operation is well known in the art, further description thereof will be omitted for the sake of brevity.

In step (D), the controller 7 obtains a deciding value based on the current weight value and the angular acceleration value.

In this embodiment, the controller 7 multiplies the current weight value with the angular acceleration value to obtain the deciding value, but the disclosure is not limited to such.

In step (E), the controller 7 stops operation of the motor 43 when the controller 7 determines that a predetermined condition is met. In this embodiment, the predetermined condition includes the controller 7 determining that the deciding value is greater than a threshold value, and that the power tool is in an operating mode.

In one embodiment, the controller 7 determines that the power tool is in the operating mode when the controller 7 receives the trigger signal indicating that the switch trigger 22 is being depressed. The threshold value may be set based on application requirements and the model type of the power tool. In such an embodiment, the lower the threshold value, the higher the sensitivity, but the probability of misjudgment will increase, whereas the higher the threshold value, the lower the probability of misjudgment, but the sensitivity will decrease.

In some embodiments, the predetermined condition further includes determining that the deciding value is greater than a starting value, where the starting value is related to the A-axis acceleration value and the B-axis acceleration value when the motor 43 is not powered on. That is to say, the controller 7 only controls the motor 43 to stop operating when the controller 7 determines that the deciding value is greater than the starting value and the threshold value, and that the power tool is in the operating mode. For example, the starting value may be obtained using methods similar to that of the methods used to obtain the deciding value, in this case the steps C) and D) mentioned above, where this time, the A-axis acceleration value and the B-axis acceleration value when the motor 43 is not powered on are used to calculate the angular acceleration value instead, and the current weight value is directly set to the high weight value. In other embodiments, the starting value may be determined by research and development personnel based on their experience after taking into consideration the A-axis acceleration value and the B-axis acceleration value when the motor 43 is not powered on. The rationale for including the controller 7 determining that the deciding value is greater than a starting value is because even when the motor 43 is not powered on, the A-axis acceleration value and the B-axis acceleration value measured by the accelerometer 511 may be a non-zero value due to the earth's gravitational pull.

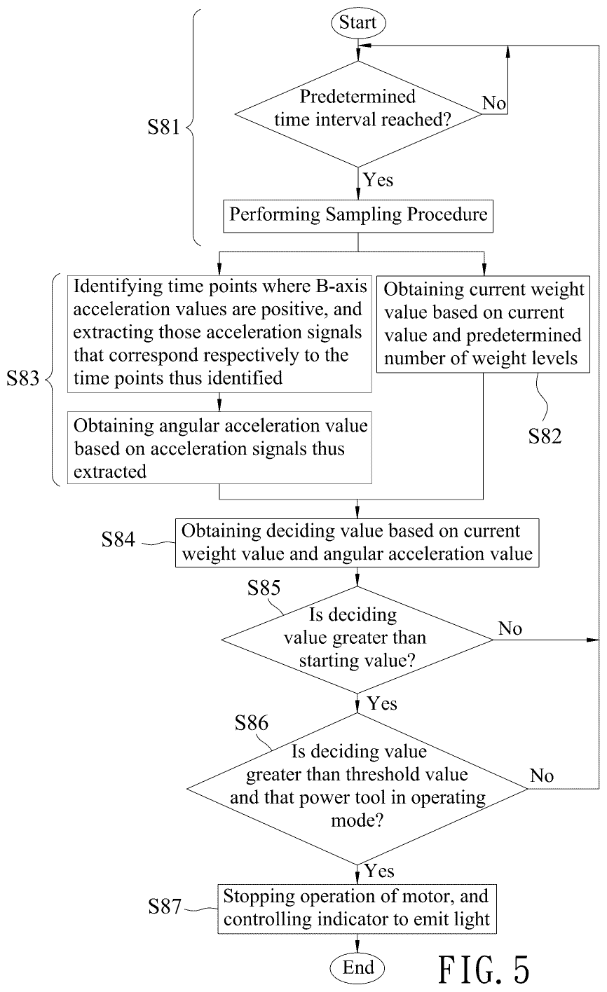

Referring to FIGS. 2, 5, and 6 to 11, a flow of the method of controlling the power tool when the power tool is in use will be described in the following using the flow chart in FIG. 5. In this embodiment, the method includes steps S81 to S87.

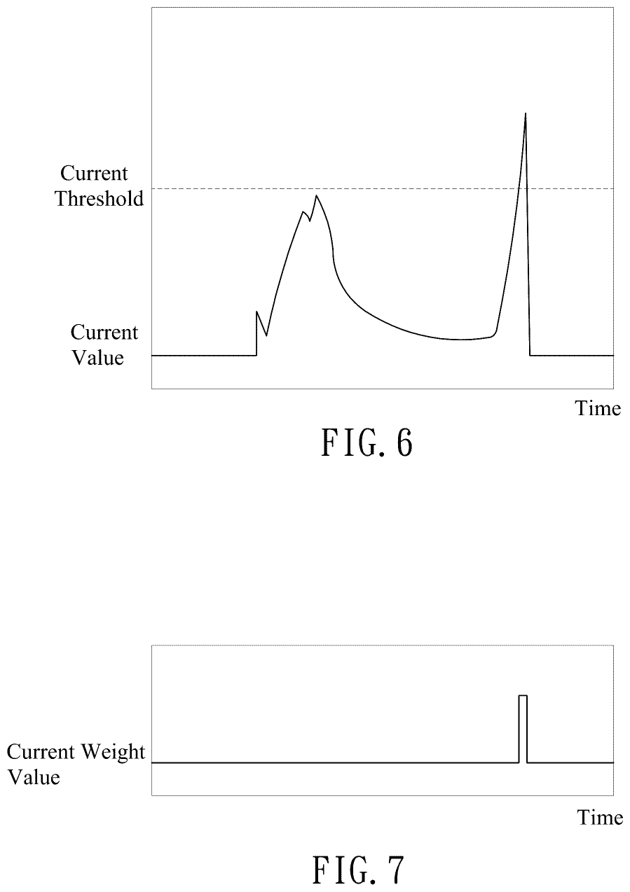

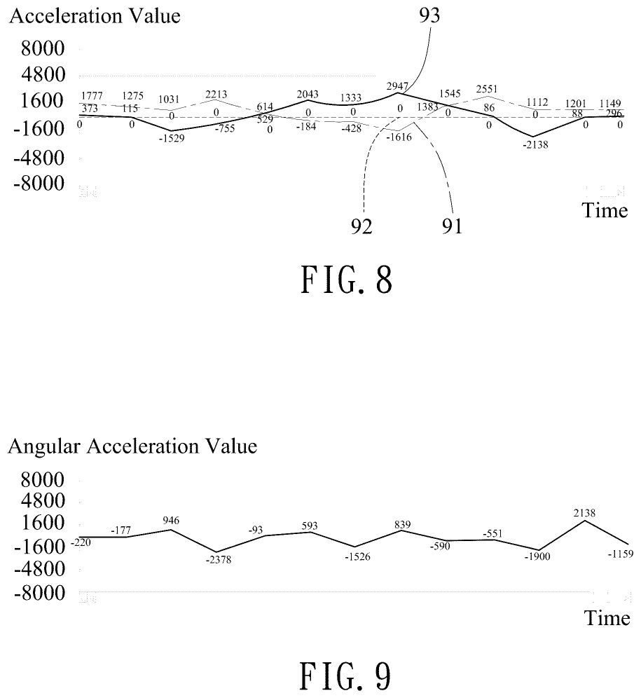

In step S81, the controller 7 performs a sampling procedure at a predetermined time interval (e.g., at a 10 millisecond interval). During the sampling procedure, the controller 7 receives the current value of the motor 43 from the current detection circuit 54, and the acceleration signals from the accelerometer 511. An example of current values of the motor 43 received over time from the current detection circuit 54 is shown in FIG. 6. The flow then goes to steps S82 and S83. In step S82, at each predetermined time interval, the controller 7 sets the current value to the low weight value (e.g., 0) or the high weight value (e.g., 1) according to the predetermined number of weight levels (e.g., 2). An example of current weight values obtained over time is shown in FIG. 7. Specifically, at each predetermined time interval, the controller 7 obtains the current weight value by comparing the current value to the current threshold. The current threshold is represented as a dotted line in FIG. 6. In step 83, since the accelerometer 511 in this embodiment is exemplified as the three-axis accelerometer, an example of the acceleration signals that include acceleration values respectively measured along the X-axis that corresponds to the A-axis, the Y-axis, and the Z-axis that corresponds to the B-axis over time is shown in FIG. 8. Referring to FIG. 8, curves that correspond to the A-axis acceleration values, Y-axis acceleration values, and the B-axis acceleration values are respectively labelled as “91”, “92”, and “93”. From the acceleration values measured in FIG. 8, the controller 7 identifies time points where the B-axis acceleration values are positive, extracts those of the acceleration signals that correspond respectively to the time points thus identified, and calculates the angular acceleration value based on the acceleration signals thus extracted. An example of angular acceleration values for the acceleration signals are as shown in FIG. 9.

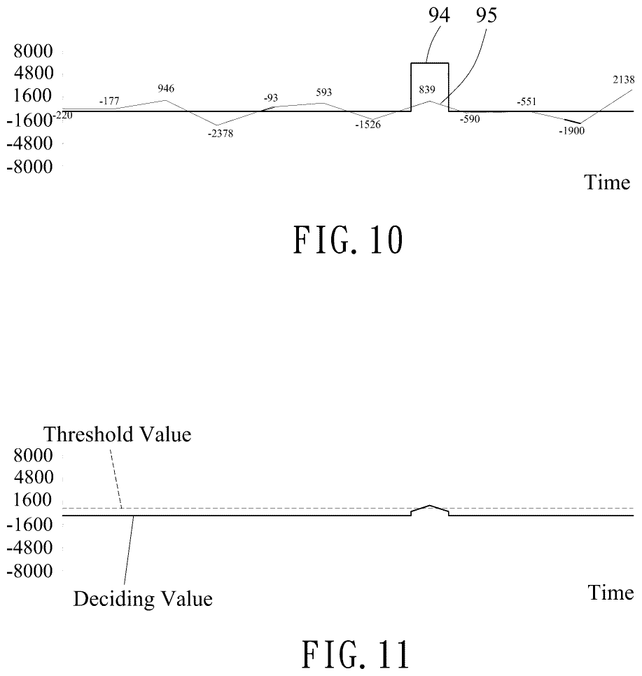

The flow then goes to step S84. In step S84, at each predetermined time interval, the controller 7 multiplies the current weight value with the angular acceleration value, which is represented by overlapping the waveform of FIG. 7 that is labelled as “94” in FIG. 10, with the waveform of FIG. 9 that is labelled as “95” in FIG. 10 to obtain the deciding value. An example of deciding values obtained over time is as shown in FIG. 11.

The flow then goes to step S85. In step S85, at each predetermined time interval, the controller 7 determines whether the deciding value is greater than the starting value. When the determination is affirmative, the flow goes to step S86. The flow goes back to S81 when otherwise. It should be noted that step S85 is optional. In some embodiments where the starting value is much smaller than the deciding value when the motor 43 has been powered on, step S85 may be omitted. In such embodiments, after step S84, the flow goes to step S86. In accordance with some embodiments, the deciding value is not smaller than 1.2 times the starting value. In accordance with some embodiments, the deciding value ranges from 1.2 times to 1.5 times the starting value. In this embodiment, the deciding value is 1.2 times the starting value.

In step S86, at each predetermined time interval, the controller 7 determines whether the deciding value is greater than the threshold value (i.e., represented in a dotted line in FIG. 11), and whether the power tool is in the operating mode. When the determination is affirmative, the flow goes to step S87. The flow goes back to step S81 when otherwise. In step S87, the controller 7 stops operation of the motor 43 to prevent a kickback situation, and simultaneously outputs the light signal to the indicator 6 to control the indicator 6 to emit light or to blink a predetermined number of times to alert the operator of an occurrence of an excessive rotation (i.e., the kickback situation).

In summary, the accelerometer 511 measures acceleration of itself on the work plane (P), and cooperates with the controller 7 to obtain the angular acceleration value based on the A-axis acceleration values and the B-axis acceleration values. The controller 7 then obtains the deciding value based on the current weight value and the angular acceleration value. Finally, the controller 7 determines whether to stop operation of the motor 43 based on the deciding value and the predetermined condition. By virtue of the abovementioned arrangements, the power tool of this disclosure is able to stop the motor 43 from rotating when the controller 7 determines that a kickback situation is imminent, thereby preventing the operator from getting injured or preventing an industrial safety accident from happening.

Furthermore, the method of controlling the power tool of this disclosure uses acceleration values, current values and the operating status of the power tool to make calculations and judgements, which produces good judgement accuracy and reduces the probability of misjudgment, thereby greatly improving the convenience of use. In addition, a conventional power tool usually includes a switch for operators to manually turn off functions that prevent the conventional power tool from determining occurrence of a kickback situation because the conventional method of controlling the conventional power tool has relatively bad judgement accuracy. However, since the power tool of this disclosure has improved judgement accuracy and is able to meet the operators' requirements, the power tool of this disclosure does not need to include this type of switch. Therefore, the power tool of this disclosure can save the space required for setting up the switch and thereby reducing the design complexity of the power tool.

Moreover, by virtue of an operator being able to set the predetermined number of weight levels to different numbers, the number of levels of the current weight value may be adjusted, thereby increasing accuracy of the determination for different applications.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method of controlling a power tool, the power tool including an accelerometer, a motor, a current detection circuit for detecting a current of the motor, and a controller, the method being implemented by the controller and comprising:
receiving a current value of the motor from the current detection circuit, and obtaining a current weight value based on the current value and a predetermined number of weight levels;
receiving a plurality of acceleration signals corresponding to different points of time from the accelerometer, the accelerometer measuring acceleration of the accelerometer on a work plane over time to generate the plurality of acceleration signals, the work plane having an A-axis, and a B-axis that is perpendicular to the A-axis, each of the plurality of acceleration signals including an A-axis acceleration value related to an acceleration measured along the A-axis, and a B-axis acceleration value related to an acceleration measured along the B-axis;
obtaining an angular acceleration value based on the plurality of acceleration signals, the angular acceleration value corresponding to an angular acceleration of the power tool on the work plane;
obtaining a deciding value based on the current weight value and the angular acceleration value; and
in response to a predetermined condition being met, stopping operation of the motor, wherein the predetermined condition includes determining that the deciding value is greater than a threshold value, and that the power tool is in an operating mode.

2. The method as claimed in claim 1, the power tool further including a chuck that has a rotation axis, and that extends along the rotation axis, wherein the work plane intersects the rotation axis.

3. The method as claimed in claim 1, the power tool further including a switch trigger configured to output a trigger signal upon being depressed, wherein the controller determines that the power tool is in the operating mode when the controller receives the trigger signal indicating that the switch trigger is being depressed.

4. The method as claimed in claim 1, wherein the controller obtaining the angular acceleration value includes:
identifying time points where the B-axis acceleration values are positive, and extracting those of the plurality of acceleration signals that correspond respectively to the time points thus identified; and
calculating the angular acceleration value based on the A-axis acceleration values and the B-axis acceleration values of those of the plurality of acceleration signals.

5. The method as claimed in claim 4, wherein calculating the angular acceleration value includes performing a differencing operation on the A-axis acceleration values and the B-axis acceleration values of those of the plurality of acceleration signals, and calculating the angular acceleration value based on results obtained from performing the differencing operation.

6. The method as claimed in claim 1, wherein the predetermined number of weight levels is two, and corresponds to a current threshold; and
wherein in response to the current value of the motor being greater than the current threshold, the controller sets the current weight value to a high weight value, otherwise the controller sets the current weight value to a low weight value that is smaller than the high weight value.

7. The method as claimed in claim 1, wherein the predetermined number of weight levels is three, and corresponds to a first current threshold, and a second current threshold that is smaller than the first current threshold; and
wherein in response to the current value of the motor being greater than the first current threshold, the controller sets the current weight value to a high weight value, in response to the current value of the motor being not greater than the first current threshold and greater than the second current threshold, the controller sets the current weight value to a medium weight value, otherwise the controller sets the current weight value to a low weight value, the high weight value being greater than the medium weight value, the medium weight value being greater than the low weight value.

8. The method as claimed in claim 1, wherein the predetermined number of weight levels is N, and corresponds to (N−1) number of different current thresholds defining N number of current regions, that correspond respectively to N number of weight levels, where N is a positive integer greater than one,
wherein N number of different weight values are respectively assigned to the N number of current regions, and are positively correlated with current levels represented by the N number of current regions, respectively, and
wherein the controller obtaining the current weight value includes the controller selecting one of the N number of current regions that covers the current value of the motor, and selecting one of the N number of different weight values that corresponds to said one of the N number of current regions as the current weight value.

9. The method as claimed in claim 1, wherein the predetermined condition further includes determining that the deciding value is greater than a starting value, and the starting value is related to the A-axis acceleration value and the B-axis acceleration value when the motor is not powered on.

10. A power tool, comprising:
an accelerometer configured to measure acceleration of said accelerometer on a work plane over time to generate a plurality of acceleration signals corresponding to different points of time, the work plane having an A-axis, and a B-axis that is perpendicular to the A-axis, each of the plurality of acceleration signals including an A-axis acceleration value related to an acceleration measured along the A-axis, and a B-axis acceleration value related to an acceleration measured along the B-axis;
a motor configured to receive a control signal, and operate based on the control signal thus received;
a current detection circuit disposed in correspondence to said motor, and configured to detect a current of said motor to output a current signal indicating a current value of said motor based on the current thus detected; and
a controller communicatively connected to said accelerometer, said motor, and said current detection circuit, and configured to receive the plurality of acceleration signals and the current signal, output the control signal, and perform the method as claimed in claim 1.

11. The power tool as claimed in claim 10, further comprising a chuck that has a rotation axis, and that extends along the rotation axis, wherein the work plane intersects the rotation axis.

12. The power tool as claimed in claim 10, further comprising a switch trigger configured to output a trigger signal upon being depressed, wherein said controller determines that said power tool is in the operating mode when said controller receives the trigger signal indicating that said switch trigger is being depressed.

13. The power tool as claimed in claim 10, wherein said controller is configured to extract those of the plurality of acceleration signals whose B-axis acceleration values are positive, and calculate the angular acceleration value based on the A-axis acceleration values and the B-axis acceleration values of those of the plurality of acceleration signals to obtain the angular acceleration value.

14. The power tool as claimed in claim 13, wherein said controller is configured to perform a differencing operation on the A-axis acceleration values and the B-axis acceleration values of those of the plurality of acceleration signals, and calculate the angular acceleration value based on results obtained from performing the differencing operation.

15. The power tool as claimed in claim 10, wherein the predetermined number of weight levels is two, and corresponds to a current threshold; and
wherein said controller is configured to, in response to the current value of said motor being greater than the current threshold, set the current weight value to a high weight value, otherwise set the current weight value to a low weight value that is smaller than the high weight value.

16. The power tool as claimed in claim 10, wherein the predetermined number of weight levels is three, and corresponds to a first current threshold, and a second current threshold that is smaller than the first current threshold; and
wherein said controller is configured to: in response to the current value of said motor being greater than the first current threshold, set the current weight value to a high weight value; in response to the current value of said motor being not greater than the first current threshold and greater than the second current threshold, set the current weight value to a medium weight value; otherwise set the current weight value to a low weight value, the high weight value being greater than the medium weight value, and the medium weight value being greater than the low weight value.

17. The power tool as claimed in claim 10, wherein the predetermined number of weight levels is N, and corresponds to (N−1) number of different current thresholds defining N number of current regions, that correspond respectively to N number of weight levels, where N is a positive integer greater than one;
wherein N number of different weight values are respectively assigned to the N number of current regions, and are positively correlated with current levels represented by the N number of current regions, respectively; and
wherein said controller is configured to select one of the N number of current regions that covers the current value of said motor, and select one of the N number of different weight values that corresponds to said one of the N number of current regions as the current weight value.

18. The power tool as claimed in claim 10, wherein the predetermined condition further includes said controller determining that the deciding value is greater than a starting value, and the starting value is related to the A-axis acceleration value and the B-axis acceleration value of the B-axis when said motor is not powered on.
